(19) United States
(12) Patent Application Publication
(10) Pub. No.: US 2005/0060314 A1
(43) Pub. Date: Mar. 17, 2005

(54) System and methods involving a data structure searchable with O(logN) performance

(76) Inventors: Lanzhong Wang, Fort Collins, CO (US); Richard A. Ferreri, Fort Collins, CO (US); John R. Applin, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/829,488

(22) Filed: Apr. 22, 2004

Related U.S. Application Data
(60) Provisional application No. 60/498,942, filed on Aug. 29, 2003.

(51) Int. Cl. G06F 7/00

(52) U.S. Cl. 707/7

(57) ABSTRACT

One embodiment of the invention involves a data structure that is stored on a computer-readable medium comprising a sorted portion that contains a plurality of entries that are sorted into an order, an unsorted portion that contains a plurality of entries that have not been sorted, and a boundary that separates the sorted portion and the unsorted portion. The sorted portion of the data structure may be searched with O(logN) performance while an entry is added to the unsorted portion.

### CROSS-REFERENCE TO RELATED APPLICATIONS

This application claims priority benefit of U.S. Provisional Patent Application No. 60/498,942 entitled “SYSTEMS AND METHODS INVOLVING DESIGNS,” filed Aug. 29, 2003, the disclosure of which is hereby incorporated herein by reference. The present application is related to co-pending and commonly assigned U.S. patent application Ser. Nos. [Attorney Docket No. 100204073-1] entitled “SYSTEMS AND METHODS THAT SUPPORT HIERARCHICAL NET NAMING CONVENTIONS USED BY TIMING ANALYSIS TOOLS,” [Attorney Docket No. 200206536-1] entitled “ADDING NEW NODES INTO AN EXISTING OCCURRENCE MODEL,” [Attorney Docket No. 200310448-1] entitled “SYSTEMS AND METHODS FOR DELETING OBJECTS IN AN OCCURRENCE MODEL OF A CIRCUIT,” filed concurrently herewith, the disclosure of which is hereby incorporated by reference. This application is related to commonly assigned U.S. patent application Ser. No. 09/709,695 entitled “MEMORY EFFICIENT OCCURRENCE MODEL DESIGN FOR VLSI CAD”, filed Nov. 10, 2000, and commonly assigned U.S. patent application Ser. No. 09/779,965 entitled “METHOD AND APPARATUS FOR TRAVERSING NET CONNECTIVITY THROUGH DESIGN HIERARCHY, filed Feb. 9, 2001, the disclosures of which are hereby incorporated herein by reference.

### FIELD OF THE INVENTION

This invention relates in general to computer data structures and in specific to a data structure memory that is efficient for storage and allows for fast insertion and retrieval.

### DESCRIPTION OF THE RELATED ART

Computer applications typically use data structures to maintain data in a manner that allows for the addition of data to the structure and the retrieval of data from the structure. Consider the data structures supported by the C++ Standard Template Library (STL). STL associative containers typically support fast addition/retrieval of items to/from the container. For further information, see “Generic Programming and the STL,” by Matthew H. Austern, page 160, which is incorporated herein by reference. The complexity of inserting items into such a container is in general O(NlogN), where N is the total number of desired items. The complexity for finding/retrieving is typically logarithmic, e.g. O(logN). STL associative containers commonly use a balanced binary tree as their underlying data structure making them memory inefficient for small storage items. Because many applications have the need to efficiently store large amounts of small-sized data items, STL associative containers cannot meet the needs of many of these applications.

In contrast, the STL vector container is very memory efficient. There is no per-item overhead when an item is stored in a vector. But its find/retrieve performance is very expensive. The computational complexity of a find/retrieve is O(N) and is not acceptable for applications such as many CAD software applications that require a minimum of O(logN) performance.

In the book “Effective STL”, by Scott Meyers, pages 100-106, Item 23, which is incorporated herein by reference, it is suggested to replace associative containers with sorted vectors to have a memory efficient data container while achieving O(logN) lookup performance. However, it will work only under certain conditions. Namely, the insertions, erasures, and lookups cannot be interleaved. In other words, the container must be sorted before searching can be performed. If unsorted items are present in the container, the search may fail. Unfortunately, this condition is often too limiting given that many applications need to intermix such operations. Consider the example of a VLSI timing tool that requires inserting several items into the container, followed by some lookup operations, followed once again by additional insertions of many more items into the container. It must be guaranteed that items being inserted are not duplicates of items that were previously inserted. This requires interleaved insert and lookup operations. However, the continual insertion of items into the container is expensive, since inserting N items into a vector is an O(N²) operation.

### BRIEF SUMMARY OF THE INVENTION

One embodiment of the invention involves a data structure that is stored on a computer-readable medium comprising a sorted portion that contains a plurality of entries that are sorted into an order, an unsorted portion that contains a plurality of entries that have not been sorted, and a boundary that separates the sorted portion and the unsorted portion. The sorted portion of the data structure may be searched with O(logN) performance while an entry is added to the unsorted portion.

### BRIEF DESCRIPTION OF THE DRAWINGS

FIG. 1 depicts an example of a container according to embodiments of the invention.

FIGS. 2A-2H depict a sequence of an example of using a container according to embodiment of the invention.

FIG. 3 depicts a flow chart of using a container according to embodiments of the invention.

FIG. 4 depicts another flow chart of using a container according to embodiments of the invention.

FIGS. 5A-F depict another sequence of an example of using a container according to embodiments of the invention.

FIGS. 6A-B depict an example of a CAD application for which the embodiment of the invention can be used.

FIGS. 7A-F depict another sequence of an example of using a container according to embodiments of the invention.

FIG. 8 depicts a block diagram of a computer system which is adapted to use the embodiments of the invention.

### DETAILED DESCRIPTION OF THE INVENTION

Embodiments of the invention involve a data structure that is stored on a computer readable medium comprising a sorted portion that contains a plurality of entries that are sorted into an order, an unsorted portion that contains a plurality of entries that have not been sorted, and a boundary that separates the sorted portion and the unsorted portion. The sorted portion of the data structure may be searched in accordance with the boundary, in other words search one portion of the container as actioned by the boundary. During operations using the data structure, the sorted portion of the data structure may be searched in accordance with the boundary for O(logN) performance, while new items can be added into the unsorted portion of the container to be sorted and merged into the sorted portion later. New items may be added in four situations. (1) The application is not concerned with duplicate items in the container. Thus, no search is needed on both portions during the addition of new items. The new items in the unsorted portion will be sorted, and then merged into the sorted portion. (2) If the new item is greater than the last item in the sorted portion of the container, then during addition of the new item, the boundary pointer is moved one slot down to include the new item in the sorted portion. The unsorted portion will remain unchanged, e.g. zero. (3) The application desires to avoid duplication, and the existence of duplication is unknown. In the case, an O(logN) search will be conducted on the sorted portion, and the O(N) search will be conducted on the unsorted portion of the container to avoid duplication. This search will continue until a predetermined threshold (e.g. number of items in the unsorted portion etc.) is reached, then a sorting operation will be performed on the unsorted portion, which is then merged into the sorted portion. (4) The application desires to avoid duplication, and the existence of duplications is known. For such a situation, an O(logN) search will be conducted on the sorted portion to avoid duplication, and the new item is simply added to the unsorted portion.

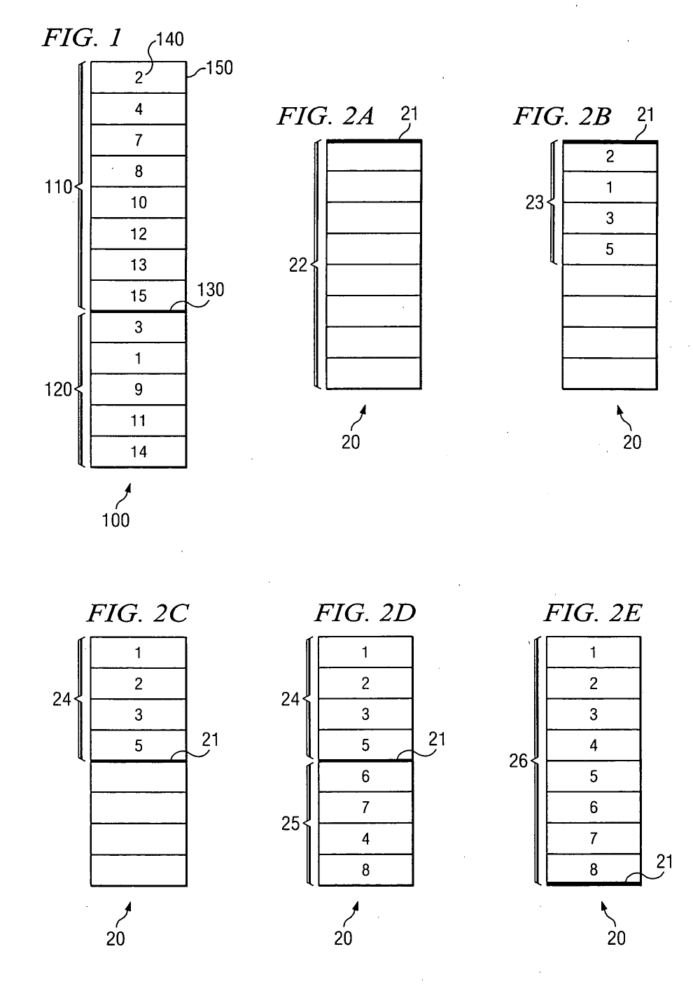

Embodiments of the invention involve a data structure that is stored on a computer readable medium comprising a sorted portion that contains a plurality of entries that are sorted into an order, an unsorted portion that contains a plurality of entries that have not been sorted, and a boundary that separates the sorted portion and the unsorted portion. Embodiments of the invention involve a container that separates the sorted items from the newly added items during insertion. The container comprises a boundary that separates the sorted portion, namely the existing contents of the container, from unsorted portion, namely the newly added items. For example, the container 100 shown in FIG. 1 comprises a plurality of storage slots 150 that hold values 140. The container comprises a sorted portion 110 wherein the values are stored in the slots in a sorted order, for example, from lowest value to highest value (or vice-versa). The sorting can also be conducted for alphabetic order, memory address, etc. The container also comprises an unsorted section 120, that contains values that have been added to the container by an application after a preceding sort operation. The boundary 130 marks the division of the container 100 between the sorted and unsorted portions. Therefore, the lookup (search) operation can still be conducted on the sorted portion with an O(logN) performance while new items are added into the unsorted portion of the container.

An application, for example, a program that uses the container in its processing, may insert a new item or new items into unsorted portion 120, without immediately initiating a sort operation on the container. This permits postponement of the sort operation to a later time, and avoids the O(N²) insertion performance (Sorting operation is O(NlogN)). A binary search with O(logN) performance, may be performed on the sorted portion 110, even though unsorted items have been inserted or are present in the container. Note that “N” is the number of items or values that are being searched.

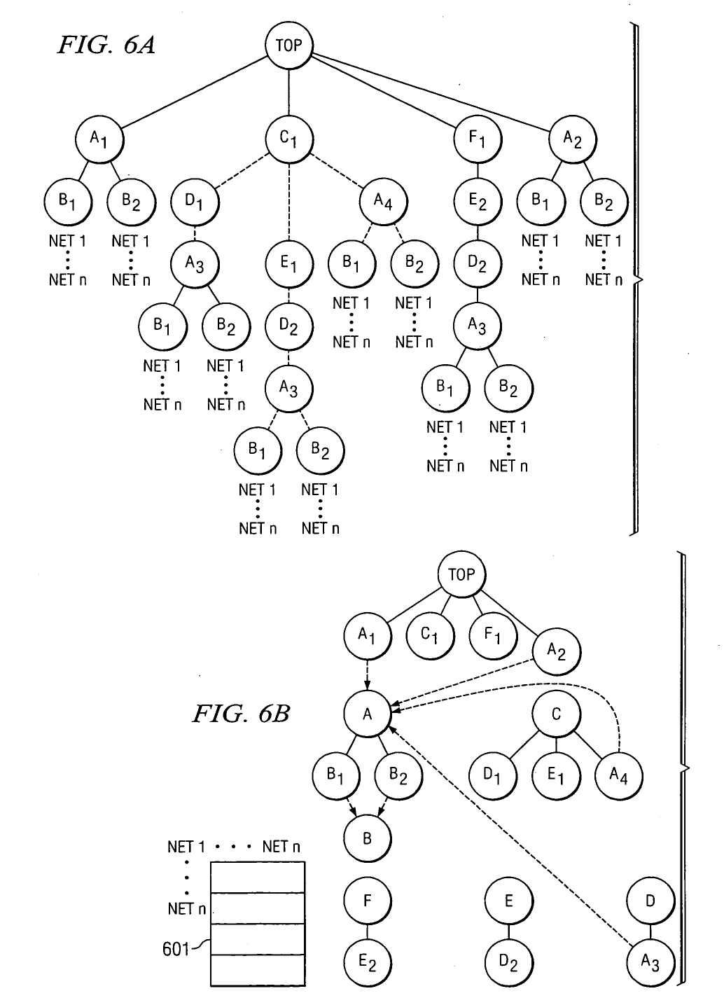

FIGS. 5A-5F depict an exemplary sequence using a container according to embodiment of the invention for the situation (1). Note that the size of the container, the arrangement of the container, the number of slots, the values stored therein, and the sorting arrangement of the values is by way of example only. In FIG. 5A, the container is empty, and the boundary 130 is set to the beginning of the container or the zero slot. Since the application does not care about duplication in the container, nine items may be added into the container without examining (search) the items for duplication. The boundary 130 remains at the same location, the size of the sorted portion is zero and the size of the unsorted portion is nine (FIG. 5B). After a sorting operation has been conducted on unsorted portion 120, then boundary 130 is moved below slot nine so the size of sorted portion 110 is nine slots and the size of the unsorted portion is zero (FIG. 5C). The O(logN) search/retrieval operation can be conducted on the container.

In FIG. 5D, seven new items are added into the container without checking for duplication. The size of sorted portion 110 remains nine while the size of unsorted portion 120 becomes seven slots. The boundary 130 remains at the same location.

In FIG. 5E, a sorting operation is only conducted on unsorted portion 120, and sorted portion 110 remains unchanged. In FIG. 5F, the two sorted portions are merged into one, and the boundary 130 is moved below slot 16. Since the sorting operation takes O(NlogN), reducing the size of N will improve the performance. Therefore, by separating the sorted and the unsorted portions in the container, sorting takes place on the unsorted portion only (followed by merging the two sorted portions), which has better performance than sorting the whole container.

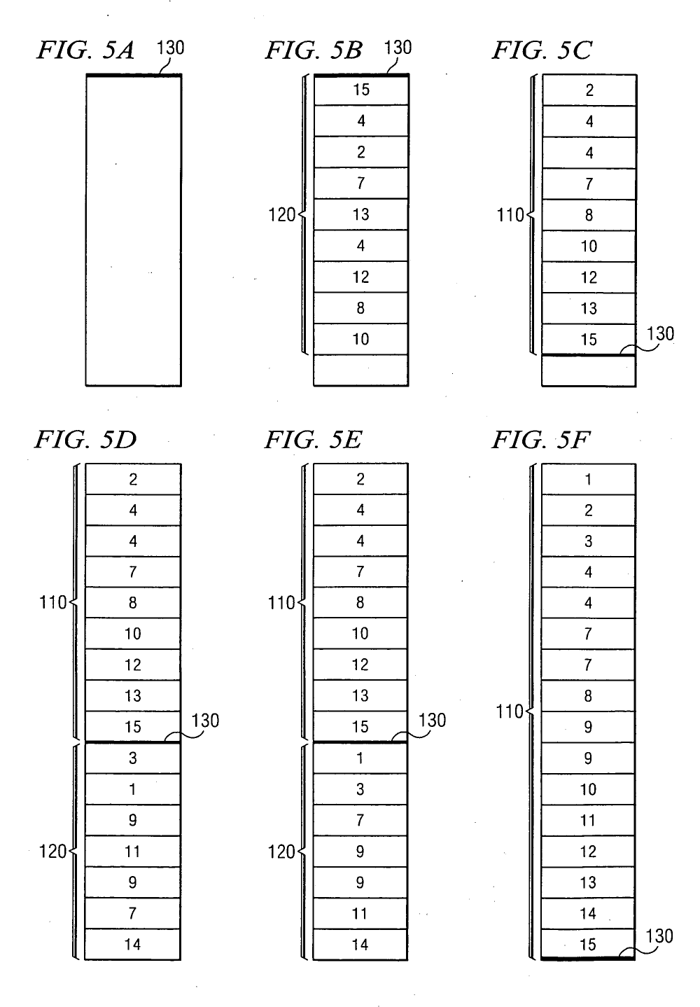

FIG. 4 depicts flow chart 400 of an exemplary embodiment of the invention operating with situation (2) and/or (3). When duplication is to be avoided within the container, a searching operation has to be conducted before a new item is added into the container. The flow chart 400 begins by receiving a new item 401. The flow chart then conducts an O(logN) search on the sorted portion of the container for the key or identifier of the new item 402. If the item is found in the container in block 403, the new item will not be added into the container 404 and the operation ends 405. If the item is not found in the sorted portion in block 403, the search will be moved onto the unsorted portion of the container. If the number of items in the unsorted portion has not reached a user specified threshold in block 406, an O(N) search operation will be conducted on the unsorted part 407. Otherwise, unsorted part is sorted and two parts (i.e. the sorted portion and the newly-sorted portion) are merged into one portion 408. After block 408, a O(logN) search may be performed on the sorted container 409. If the item is found by either of the searches 410, the new item will not be added to the container 404 and the operation ends 405. If the item is not found, then the flow chart proceeds with block 411. Block 411 determines if the size of unsorted portion is zero, and if not, the new item is added into the unsorted portion of the container 414 and the operation ends 405. If the unsorted portion is zero, then the flow chart proceeds with block 412. In block 412, the flow chart determines if the key of new item is greater than the key of last item in the sorted portion. If so, the flow chart then adds the new item to the sorted part of the container 413, effectively moving the boundary pointer one slot down, and ends the operation 405. If the key of the new item is less than the key of last item in the sorted portion, the boundary will remain at the same location and the new item will be added to the unsorted portion of the container 413. The operation then ends 405.

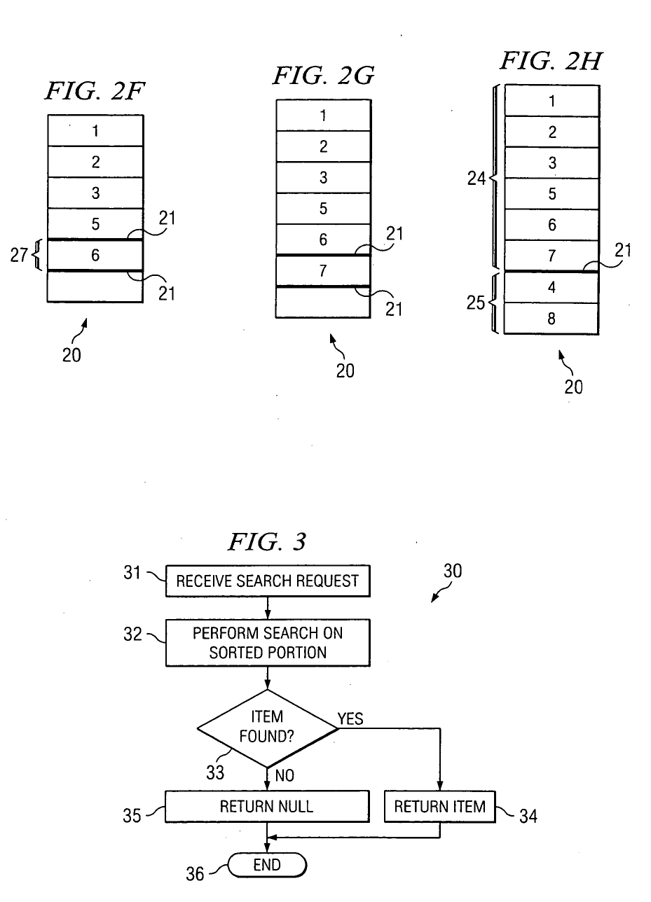

FIGS. 2A-2E depict a sequence of an example of using a container 20 according to embodiment of the invention for situation (2) and/or (3). Note that the size of the container, the arrangement of the container, the number of slots, the values stored therein, and the sorting arrangement of the values is by way of example only. In FIG. 2A, the container 20 is empty, and the boundary 21 is set to the beginning of the container or the zero slot. The size of both the sorted portion and the unsorted portion is zero. In FIG. 2B, the container 20 has been inserted with some unsorted values 23. Thus, the boundary 21 remains at the same location as in FIG. 2A. The size of the sorted portion is zero and the size of the unsorted portion is four. A new value is inserted only if it is not present in the container already.

In FIG. 2C, a sorting operation is performed to form sorted portion 24. Note that the sorting arrangement in the ascending order is by way of example only. The sorting may have been initiated because of the lapse of a predetermined amount of time searching and/or the number of unsorted items have reached a predetermined threshold. After the sort operation, the boundary pointer will be moved to the location after the last sorted item in the container. All the values in the sorted portion 24 can be searched and retrieved using a binary search with O(logN) performance. The size of the sorted portion 24 is four and the size of the unsorted portion is zero.

In FIG. 2D, the container 20 will be filled with some new values 25. Since the first new item (6) is greater than the last item in the sorted portion (5), the new item (6) may be added into the sorted portion, and the boundary 21 will be moved one slot lower. The unsorted portion remains zero, and the size of sorted portion becomes five (FIG. 2F). In FIG. 2G, the next item (7) is added into the container, once again the new item is greater than the last item in the sorted portion (6), the next item (7) will be added into the sorted portion. The unsorted portion still remains zero, and the size of sorted portion becomes six. In FIG. 2H, the remaining of the new items, (4) and (8), are added into the container. Since the first new item is less than the last item in the sorted portion (7), the new items are sequentially added into the unsorted portion of the container so the boundary 21 remains at the same location, namely after sorted portion 24.

This container will allow a binary search on the sorted portion 24 for each new value that is to be inserted into the container. If the new value is not found, it will be inserted to the next available slot of the container in the unsorted section without sorting. All the values in the sorted portion 24 can be searched and retrieved, even during insertion of the new values, using a binary search with O(logN) performance. The size of the sorted portion is six and the unsorted is two. At the end of the addition operation, or when the number of items in the unsorted portion reaches a user-specified threshold, the unsorted portion will be sorted (in the example, the items are in a sorted order already), then merged into one sorted chunk, and the boundary pointer 21 will be moved to the end of container (FIG. 2E). Note that for many applications, the new items that are to be added to the container are already in a sorted order. For instance, for applications that store memory pointers and use the address as sorting criteria, in most cases the new memory allocation is greater than the previously created item allocation. For such a situation, the boundary pointer 21 will just be moved down one by one, and the size of sorted portion will be increasing without any O(NlogN) sorting operation. Before any new items are added into the container, an O(logN) search will be performed on the sorted portion to insure no duplications within the container, and O(NlogN) sorting and insertion operation is avoided. However, when the searching key of the first new item is less than the last item in the sorted portion, the boundary pointer 21 will not be moved down, and the new item and all the following items will be added into the unsorted portion of the container. Therefore, before any new item addition, two different searches will be conducted on the container: a binary O(logN) search on the sorted portion, and linear O(N) search on the unsorted portion to avoid duplication. New items are continuously added to the unsorted portion until a threshold is reached, e.g. the number of items reaches to an user-specified threshold, the addition operation ends, a time period is exceeded, etc. Then, a sorting operation will be conducted on the unsorted portion, and two portions will be merged into one portion.

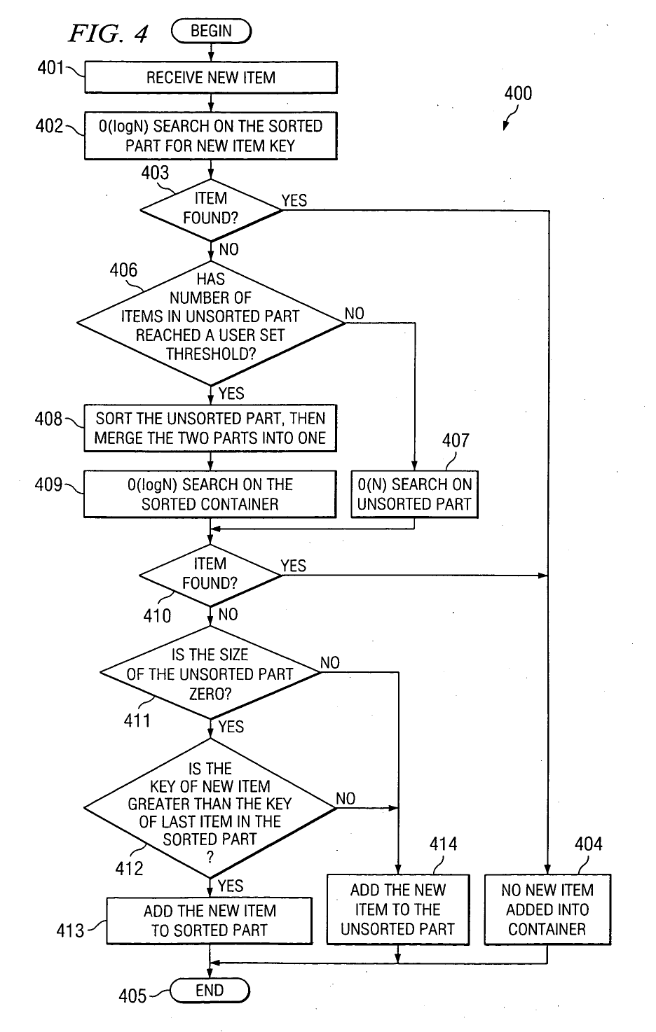

FIG. 3 depicts an example of a method 30 of using a container according to embodiments of the invention for situation (4). The method begins when an application using the container either receives or generates a search request to search for and/or retrieve a value that may be in the container, block 31. The method then searches the sorted portion of the container for the requested value, block 32. The search may comprise a binary search, which is considered useful because of its performance, namely O(LogN). The search of the container is from first slot of the container to the slot before the boundary. In block 33, if the search found a match for the requested value, then the method continues with block 34. If no match was found then the method continues with block 35. In block 34, the value is returned, and then used in processing by the application. In block 35, a null value is returned indicating that no match was found. From both blocks 34 and 35, the method then ends with block 36. This operation will be conducted before any new item added to the container.

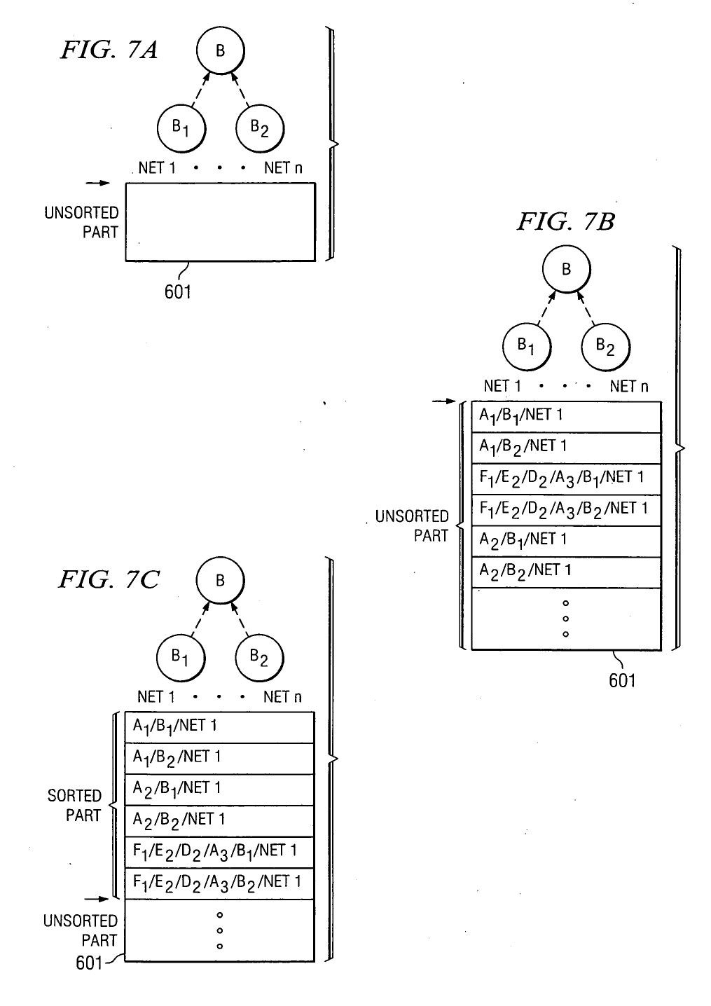

FIG. 6A shows an occurrence model, and FIG. 6B shows a folded model. A plurality of occurrence signals, such as “Top/A2/B1/net1” of FIG. 6A are stored in signal net1 601 under cell B in the folded model. In this example, the CAD application first created a partial occurrence model that contains all the nodes except every node under C1. Next the application found the occurrence tree under C1 and possibly some other nodes in the tree need to be expanded, so the occurrence model needs to be updated. During the update, all new nodes are added into the tree, but the nodes already exist in the model are not to duplicated.

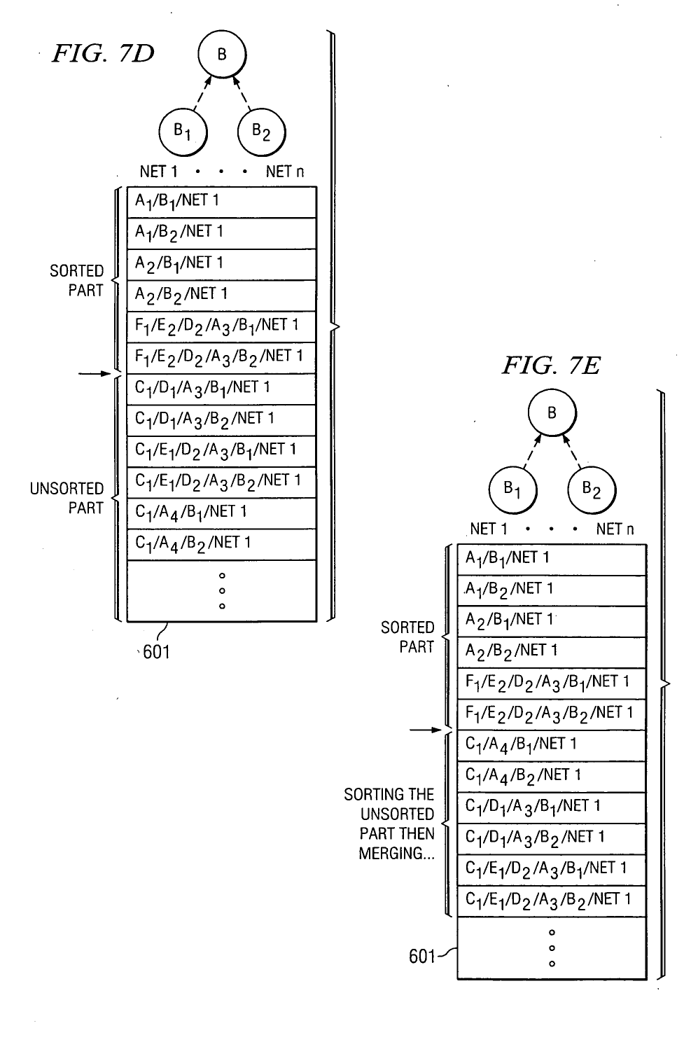

FIG. 7A-F show how the occurrence nodes associated with signal net are added to the container 601 for situation (4). Instances B1 and B2 are described by cell B, which contains signals from Net1 to Netn. All the occurrence signals for Net1 in the occurrence model will be physically stored in signal Net1, container 601. FIG. 7A shows the container 601 before any occurrence nodes are added into the container. During the partial occurrence model creation, six items are added into the container. Since each node in an occurrence model will be unique, the application does not need to check the duplication during the addition. The six items are added into the unsorted portion of the container for O(1) performance for each item being added (FIG. 7B).

After the addition is completed, the items in the container may be sorted, and thus the boundary pointer will be moved from the beginning of the container to the end of the container 601. Searching all the items within the container can be performed with an O(logN) performance (FIG. 7C). The application may then start updating the tree, whereby all the occurrence signal Net1 nodes will need to be added into the container. Since the application knows that any newly created nodes under C1 will be unique, no duplication will happen. However, the nodes that are already in the tree need to be checked to avoid duplication with the new items. During the update, a binary search will be performed on the items before the boundary (in sorted portion of the container), a new item will be added into the unsorted portion of the container as long as no such item is found on the sorted portion. No search is done on the unsorted portion of the container FIG. 7D shows six new items are added into the unsorted portion. After a sorting operation has been performed on the unsorted portion (FIG. 7E), then the two sorted parts are merged into one sorted portion in the container, and the whole container becomes sorted again (FIG. 7F).

When implemented in software, the elements of the present invention are essentially the code segments to perform the necessary tasks. The program or code segments can be stored in a processor-readable medium or transmitted by a computer data signal embodied in a carrier wave, or a signal modulated by a carrier, over a transmission medium. The “processor-readable medium” may include any medium that can store or transfer information. Examples of the processor-readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, intranet, etc.

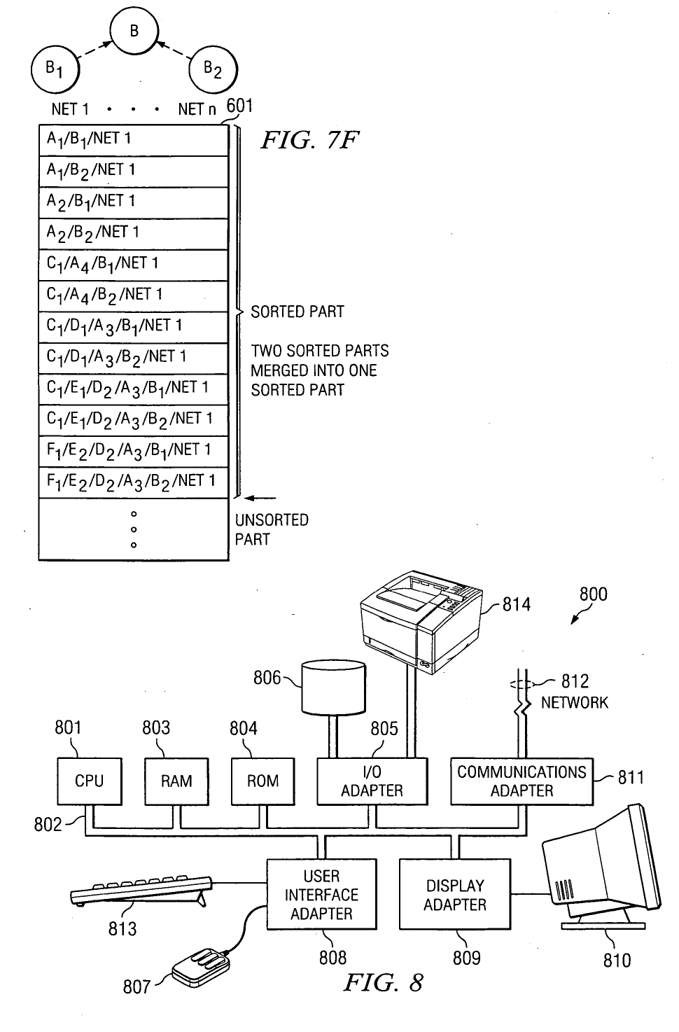

FIG. 8 illustrates computer system 800 adapted to use the present invention. Central processing unit (CPU) 801 is coupled to system bus 802. The CPU 801 may be any general purpose CPU, such as an HP PA-8500 or Intel Pentium processor. However, the present invention is not restricted by the architecture of CPU 801 as long as CPU 801 supports the inventive operations as described herein. Bus 802 is coupled to random access memory (RAM) 803, which may be SRAM, DRAM, or SDRAM. ROM 804 is also coupled to bus 802, which may be PROM, EPROM, or EEPROM. RAM 803 and ROM 804 hold user and system data and programs as is well known in the art, including embodiments of the invention.

Bus 802 is also coupled to input/output (I/O) controller card 805, communications adapter card 811, user interface card 808, and display card 809. The I/O adapter card 805 connects to storage devices 806, such as one or more of a hard drive, a CD drive, a floppy disk drive, a tape drive, to the computer system. The I/O adapter 805 may also be connected to printer 814, which would allow the system to print paper copies of information such as document, photographs, articles, etc. Note that the printer may a printer (e.g. dot matrix, laser, etc.), a fax machine, or a copier machine. Communications card 811 is adapted to couple the computer system 800 to a network 812, which may be one or more of a telephone network, a local (LAN) and/or a wide-area (WAN) network, an Ethernet network, and/or the Internet network. User interface card 808 couples user input devices, such as keyboard 813, and/or pointing device 807, to the computer system 800. The display card 809 is driven by CPU 801 to control the display on display device 810.

1. A data structure that is stored on a computer-readable medium comprising:
a sorted portion that contains a plurality of entries that are sorted into an order;
an unsorted portion that contains a plurality of entries that have not been sorted; and
a boundary that separates the sorted portion and the unsorted portion;
wherein the sorted portion of the data structure may be searched with O(logN) performance while an entry is added to the unsorted portion.

2. The data structure of claim 1, wherein the sorted portion may be searched with a binary search.

3. The data structure of claim 1, wherein the unsorted portion may be searched with an incremental search.

4. The data structure of claim 1, wherein the data structure may be sorted to form a new sorted portion that comprises the plurality of entries of the sorted portion and the plurality of entries of the unsorted portion, and the plurality of entries of the new sorted portion are sorted into an order.

5. The data structure of claim 1, wherein the data structure is associated with an occurrence model used in designing a circuit.

6. A method of using a container that comprises a sorted portion that contains a plurality of entries that are sorted into an order, an unsorted portion that contains a plurality of entries that have not been sorted, and a boundary that separates the sorted portion and the unsorted portion, the method comprising:
receiving a search request that comprises a requested value;
searching the sorted portion of the container for the requested value with O(logN) performance;
adding an entry to the unsorted portion during the searching; and
returning a stored value of the container if there is a match of the stored value and the requested value.

7. The method of claim 6, wherein when there is not a match, the method further comprises:
returning a null value that indicates that there is no match with the requested value.

8. The method of claim 6, wherein when there is not a match, the method further comprises:
adding an entry to the unsorted portion corresponding to the search request.

9. The method of claim 6, wherein when there is not a match, the method further comprises:
determining whether unsorted items in the container exceed a predetermined threshold;
performing a sort operation on the container, if the predetermined threshold is exceeded, thereby forming a new sorted portion that comprises the plurality of entries of the sorted portion and the plurality of entries of the unsorted portion, and the plurality of entries of the new sorted portion are sorted into an order.

10. The method of claim 9, further comprises:
searching the new sorted portion of the container for the requested value; and
returning a stored value of the container if there is a match of the stored value and the requested value.

11. The method of claim 10, wherein searching the new sorted portion comprises:
searching with O(logN) performance.

12. The method of claim 6, wherein when there is not a match, the method further comprises:
searching the unsorted portion of the container for the requested value; and
returning a stored value of the container if there is a match of the stored value and the requested value.

13. The method of claim 12, wherein the unsorted portion may be searched with an incremental search.

14. The method of claim 6, wherein when there is not a match, the method further comprises:
determining whether a size of the unsorted portion is zero;
adding an entry to the unsorted portion corresponding to the search request if the unsorted portion is not zero.

15. The method of claim 14, wherein the size of the unsorted portion is zero, the method further comprises:
determining whether the requested value of the search request is greater than the value of the last entry of the sorted portion;
adding an entry to the unsorted portion corresponding to the search request if the requested value of the search request is not greater than the value of the last entry of the sorted portion;
adding an entry to the sorted portion corresponding to the search request if the requested value of the search request is greater than the value of the last entry of the sorted portion.

16. The method of claim 6, further comprises:
using the container in an occurrence model in designing a circuit.

17. A computer program product having a computer-readable medium having computer program logic recorded thereon for inserting a new value into a container that comprises a sorted portion that contains a plurality of entries that are sorted into an order, an unsorted portion that contains a plurality of entries that have not been sorted, and a boundary that separates the sorted portion and the unsorted portion, the computer program product comprising:
code for searching the sorted portion of the container for the new value with O(logN) performance;
code for searching the unsorted portion of the container if no match is found in the search of the sorted portion with O(N) performance; and
code for inserting the new value into the container if no match is found in the search of the unsorted portion.

18. The computer program product of claim 17, wherein the code for inserting comprises:
code for determining whether to insert the new value in the sorted portion or the unsorted portion of the container.

19. The computer program product of claim 17, further comprises:
code for sorting the unsorted portion and merging the sorted portion and the sorted unsorted portion into a new sorted portion, wherein the code for sorting is operative when the unsorted portion exceeds a predetermined criteria; and
code for searching the new sorted portion of the container for the new value with O(logN) performance.

20. The computer program product of claim 17, further comprises:
code for a circuit design.

21. A computer system for managing data objects, comprising:
means for storing said data objects;
means for identifying a boundary within said means for storing, wherein data objects stored in a first portion of said storing means defined by said boundary are stored in an ordered manner and data objects stored in a second portion of said storing means defined by said boundary are stored in an unordered manner; and
means for searching said first portion according to O(logN) performance to locate an identified object.

22. The computer system of claim 21 further comprising:
means for searching said second portion for said identified object according to O(N) performance.

23. The computer system of claim 21 further comprising:
means for adding said identified object to said second portion when said means for searching said first portion and said means for searching said second portion do not locate said identified object.

24. The computer system of claim 21 further comprising:
means for merging data objects in said second portion into said first portion in an ordered manner; and
means for resetting said boundary in response to said means for merging.

25. The computer system of claim 24 wherein said means for merging is operable when a number of data objects in said second portion reaches a predetermined amount.
